(19) United States
(12) Patent Application Publication
(10) Pub. No.: US 2026/0221700 A1
(43) Pub. Date: Jul. 30, 2026

(54) Header for Electrical Connector Assembly and Related Method

(71) Applicant: Aptiv Technologies AG, Schaffhausen (CH)

(72) Inventor: Daniel Calvillo Hernandez, Ramos Arizpe (MX)

(21) Appl. No.: 19/038,810

(22) Filed: Jan. 28, 2025

(51) Int. Cl. H01R 13/73

(52) U.S. Cl. CPC H01R 13/73; H01R 2201/26

(57) ABSTRACT

A header is configured for connection with a tray. The header includes a base, a tab, and a surface. The base defines an aperture extending through the base and configured to receive a connector. The tab extends from the base in a first direction and is configured to suppress translation of the header relative to the tray in a second direction transverse to the first direction. The surface extends from the base in the second direction and is configured to suppress rotation of the header relative to the tray.

The present disclosure relates to a header and more particularly to a header for an electrical connector assembly.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Some connector assemblies may use a header assembly to facilitate the connection of mating connectors. Assembling current header assemblies can be time-and labor-intensive due to the precise alignment required. While known header assemblies for vehicle connection systems have proven acceptable for their intended purpose, a continuous need for improvement remains in the pertinent art to address the challenges associated with assembling header assemblies.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Aspects of the disclosure provide a header configured for connection with a tray. The header includes a base, a tab, and a surface. The base defines an aperture extending through the base. The aperture is configured to receive a connector. The tab extends from the base in a first direction and is configured to suppress translation of the header relative to the tray in a second direction transverse to the first direction. The surface extends from the base in the second direction and is configured to suppress rotation of the header relative to the tray.

Other aspects of the disclosure provide a method of coupling a header to a tray. The header includes a base defining an aperture configured to receive a connector. The header also includes a tab extending from the base in a first direction, and a surface extending from the base in a second direction. The method includes disposing the tab in a second aperture of the tray. The method further includes rotating the header relative to the tray to engage the surface with the tray and, thereby, suppress rotation of the header relative to the tray.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an exploded view of an example header assembly according to the principles of the present disclosure.

FIG. 2 is a top perspective view of the header assembly of FIG. 1 in an assembled configuration.

FIG. 3 is a bottom perspective view of the header assembly of FIG. 1 in an assembled configuration.

FIG. 4 is a bottom view of the header assembly of FIG. 1 in an assembled configuration.

FIG. 5 is a perspective view of an example header of a header assembly according to the principles of the present disclosure.

FIG. 6 is a perspective view of an example tray of a header assembly according to the principles of the present disclosure.

FIGS. 7 and 8 are top views depicting assembly of the header assembly of FIG. 1.

FIG. 9 is flowchart depicting an example method for assembling the header assembly of FIG. 1.

In the drawings, reference numbers may be reused to identify similar and/or identical elements.

### DETAILED DESCRIPTION

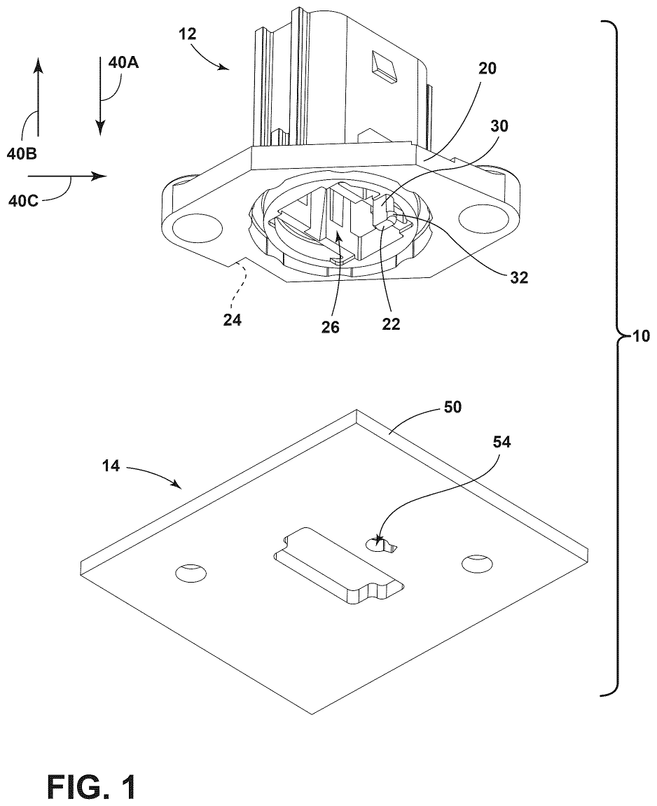

With reference to FIGS. 1-4, an example header assembly 10 is shown. As will be explained in more detail below, the header assembly 10 may be installed in a vehicle (e.g., an automobile) to facilitate the transmission of electricity between various electronic components within the vehicle. For example, the header assembly 10 may be detachably coupled to a mating connector assembly (not shown) such that, during operation, of the vehicle, electricity is transmitted between the assemblies and to various electronic components within the vehicle. In various implementations, the header assembly 10 includes a header 12 and a tray 14, among others. The header 12 is removably coupled to the tray 14.

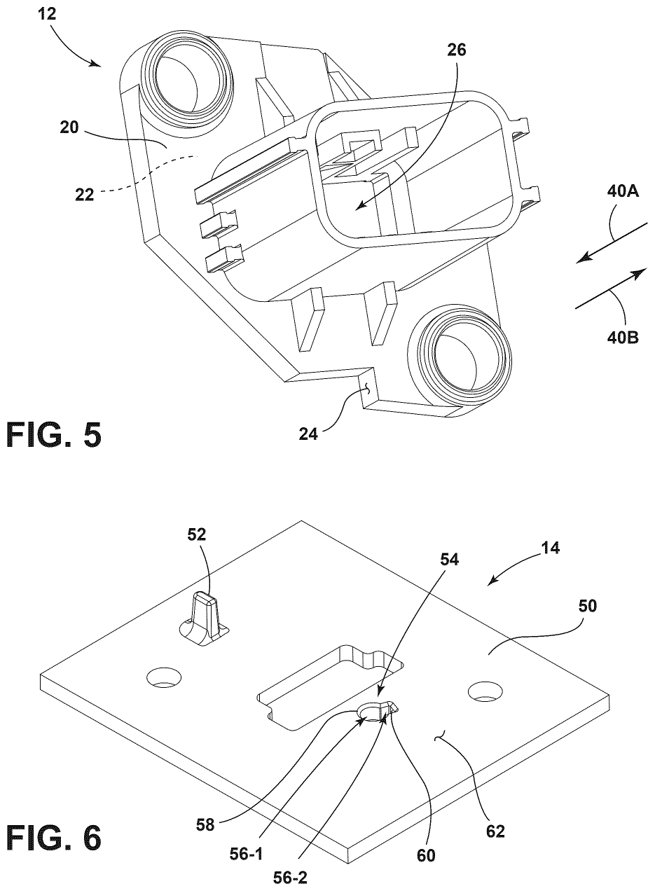

With reference to FIGS. 1 and 5, an example header 12 is shown. The header 12 may comprise one or more of a variety of shapes, sizes, configurations, and/or materials. In various implementations, the header 12 includes a base 20, a tab 22, and a surface 24, among others. The base 20 may define an aperture 26 that extends through the base 20 in a first direction 40A. The aperture 26 may receive a mating connector (not shown).

In various implementations, the tab 22 includes a base portion 30 and a lip 32 extending from the base portion 30. The tab 22 may extend from the base 20 in the first direction 40A. As will be explained in further details below, in an assembled configuration, the tab 22 engages a portion of the tray 14 to suppress translation of the header 12 relative to the tray 14 in a second direction 40B transverse to the first direction 40A (see, e.g., FIG. 3). The second direction 40B may be opposite the first direction 40A. In various implementations, the lip 32 may extend from the base portion 30 in a third direction 40C. The third direction 40C may be orthogonal to the first direction 40A.

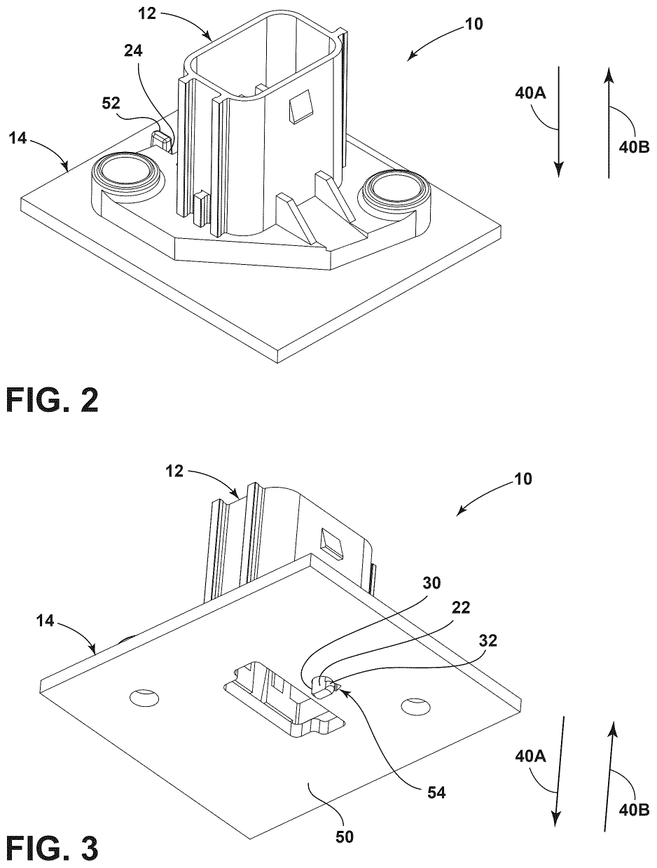

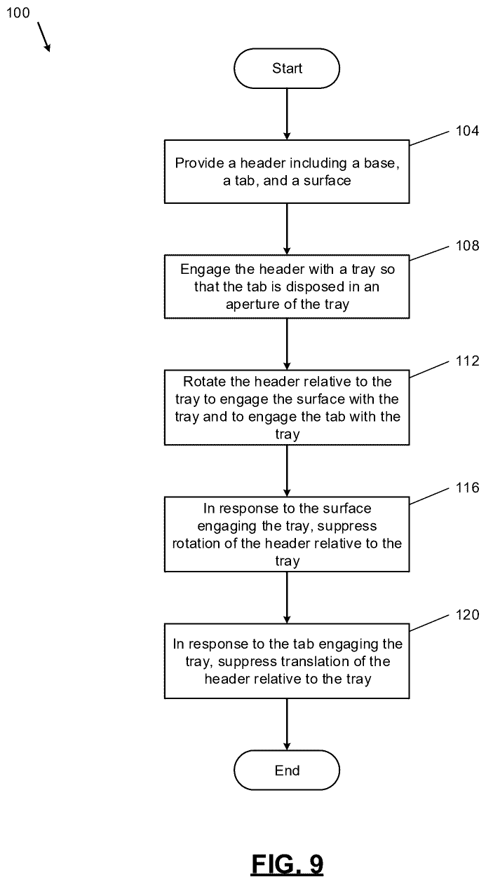

In various implementations, the surface 24 extends from the base 20 in the second direction 40B. As will be explained in further details below, in the assembled configuration, the surface 24 engages a portion of the tray 14 to suppress rotation of the header 12 relative to the tray 14 (see, e.g., FIGS. 2 and 8).

With reference to FIG. 6, an example tray 14 is shown. The tray 14 may comprise one or more of a variety of shapes, sizes, configurations, and/or materials. In various implementations, the tray 14 includes a base 50 and a projection 52 extending from the base 50. The base 50 defines an aperture 54 that receives the tab 22 of the header 12. For example, the base portion 30 and the lip 32 of the tab 22 are received by the aperture 54. As illustrated in FIG. 6, the aperture 54 may define a non-circular (e.g., polygonal) shape. In particular, the aperture 54 may include a first portion 56-1 defined by an arcuate surface 58 of the base 50, and a second portion 56-2 defined by a polygonal surface 60 of the base 50.

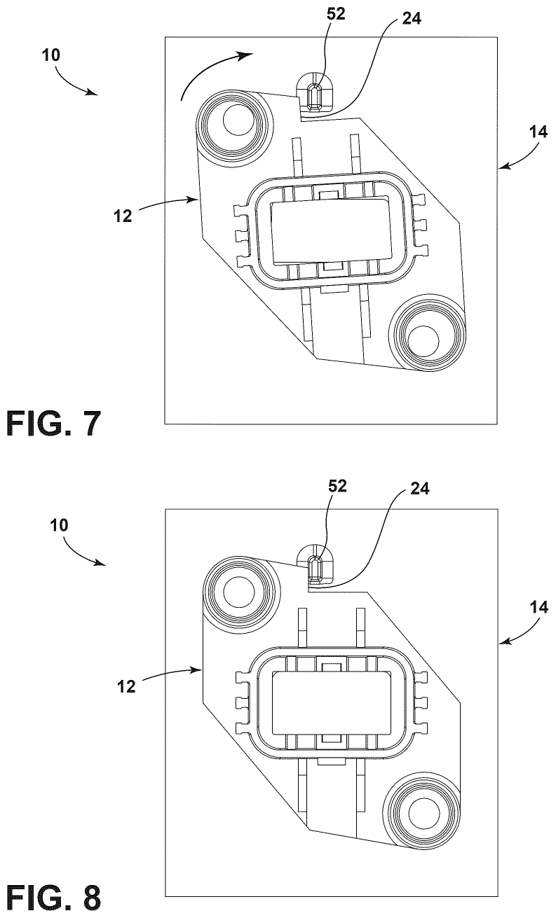

In various implementations, in response to the tab 22 being disposed within the aperture 54, the header 12 rotates (e.g., in a clockwise direction) such that the surface 24 of the header 12 engages the projection 52 of the tray 14 (see, e.g., FIGS. 7 and 8). In response to the surface 24 engaging the projection 52, rotation of the header 12 relative to the tray 14 is suppressed (e.g., in the clockwise direction).

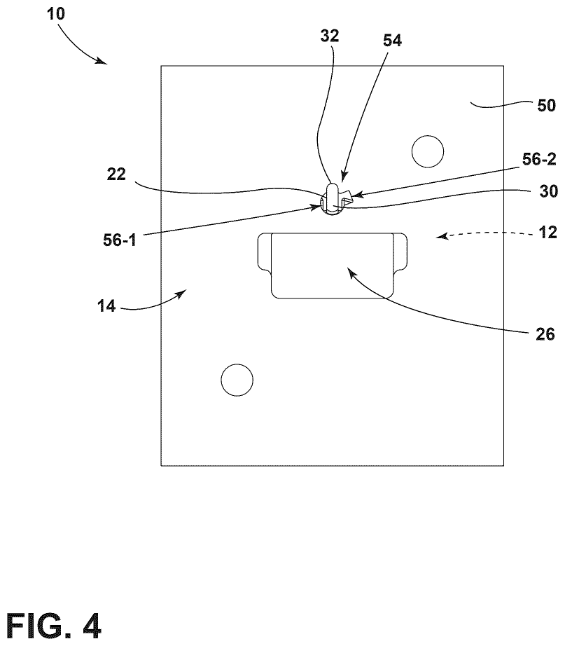

In various implementations, in response to the header 12 being rotated so that the surface 24 engages the projection 52, the lip 32 of the tab 22 engages the tray 14 to suppress translation of the header 12 relative to the tray 14 in the second direction 40B (see, e.g., FIGS. 3 and 4).

FIG. 9 is a flowchart of an example method 100 for assembling a header assembly 10. The method 100 may begin at 104. At 104, the method 100 may include providing a header 12 including a base 20, a tab 22, and a surface 24. The base 20 may define an aperture 26 extending through the base 20 in a first direction 40A. The tab 22 may extend from the base 20 in the first direction 40A. The surface 24 may extend from the base in a second direction 40B. The second direction 40B may be opposite the first direction 40A. The tab 22 may include a base portion 30 and a lip 32 extending from the base portion 30. The lip 32 may extend from the base portion 30 in a third direction 40C. The third direction 40C may be orthogonal to the first direction 40A. The method 100 may proceed to 108.

At 108, the method 100 may include engaging (e.g., by a user, a tool, a robot, etc.) the header 12 with a tray 14 so that that tab 22 is disposed in an aperture 54 of the tray 14. In various implementations, engaging the header 12 with the tray 14 includes engaging the base 20 of the header 12 with a base 50 of the tray 14. In various implementations, disposing the tab 22 in the aperture 54 of the tray 14 includes disposing the base portion 30 and the lip 32 in the aperture 54. In particular, the tab 22 may be disposed through a front surface 62 of the base 50 by aligning the lip 32 with the second portion 56-2 of the aperture 54, and translating the tab 22 through the aperture 54. The method 100 may proceed to 112.

At 112, the method 100 may include rotating (e.g., by a user, a tool, a robot, etc.) the header 12 relative to the tray 14 (e.g., in a clockwise direction) to engage the surface 24 of the header 12 with the tray 14 (see, e.g., FIG. 7). In various implementations, rotating the header 12 relative to the tray 14 includes engaging the lip 32 of the header 12 with the tray 14. The method 100 may proceed to 116.

At 116, in response to the surface 24 engaging the tray 14, the method 100 may include suppressing rotation of the header 12 relative to the tray 14 (e.g., in the clockwise direction). In various implementations, the surface 24 engages a projection 52 of the tray 14 to suppress rotation of the header 12 relative to the tray 14. The method 100 may proceed to 120.

At 120, in response to the tab 22 engaging the tray 14, the method 100 may include suppressing translation of the header 12 relative to the tray 14 in the section direction 40B. For example, the lip 32 of the tab 22 may engage the tray 14 to suppress translation of the header 12 in the second direction 40B. In various implementations, in response to the surface 24 engaging the projection 52, a set of fasteners (not shown) may be used to secure the header 12 to the tray 14. For example, a fastener may be disposed in corresponding holes of the header 12 and tray 14 to secure the header 12 to the tray 14. Then, the method 100 may end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set —in other words, in some circumstances a “set” may have zero elements. The term “non-empty set” may be used to indicate exclusion of the empty set —in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for a header for an electrical connector assembly and related method, as described above.

Clause 1: A header configured for connection with a tray, the header comprising: a base defining a first aperture extending through the base and configured to receive a connector; a tab extending from the base in a first direction and configured to suppress translation of the header relative to the tray in a second direction transverse to the first direction; and a surface extending from the base in the second direction and configured to suppress rotation of the header relative to the tray.

Clause 2: The header of clause 1, wherein the tab is disposed within a second aperture of the tray.

Clause 3: The header of clause 2, wherein, in response to the tab being disposed within the second aperture, the header is configured to rotate such that the surface engages the tray.

Clause 4: The header of clause 3, wherein the surface is configured to engage the tray to suppress rotation of the header relative to the tray.

Clause 5: The header of any of clauses 3 through 4, wherein the surface is configured to engage a projection of the tray to suppress rotation of the header relative to the tray.

Clause 6: The header of any of clauses 1 through 5, wherein the tab is configured to engage the tray to suppress translation of the header in the second direction.

Clause 7: The header of any of clauses 1 through 6, wherein the second direction is opposite the first direction.

Clause 8: The header of any of clauses 1 through 7, wherein the tab includes a base portion and a lip extending from the base portion in a third direction.

Clause 9: The header of clause 8, wherein the base portion and the lip are received by a second aperture of the tray, and wherein, in response to the header being rotated so that the surface engages the tray, the lip is configured to engage the tray to suppress translation of the header in a fourth direction.

Clause 10: The header of any of clauses 8 through 9, wherein the third direction is orthogonal to the first direction.

Clause 11: The header of any of clauses 1 through 10, wherein the first aperture extends through the base in the first direction.

Clause 12: An assembly comprising: the header of clause 1; and the tray, wherein the tray includes a second aperture configured to rotatably-receive the tab.

Clause 13: The assembly of clause 12, wherein the second aperture includes a first portion defined by an arcuate surface of the base, and a second portion defined by a polygonal surface of the base, and wherein the tab is configured to translate through the second portion.

Clause 14: The assembly of clause 13, wherein the tray includes a front surface and a rear surface opposite the front surface, and wherein the rear surface is configured to engage the tab upon rotation of the header relative to the tray.

Clause 15: The assembly of clause 14, wherein the tab includes a base portion and a lip extending from the base portion in a third direction, and wherein the lip is configured to engage the rear surface upon rotation of the header relative to the tray.

Clause 16: A method of coupling a header to a tray, the header including a base defining an aperture configured to receive a connector, a tab extending from the base in a first direction, and a surface extending from the base in a second direction, the method comprising: disposing the tab in a second aperture of the tray; and rotating the header relative to the tray to engage the surface with the tray and, thereby, suppress rotation of the header relative to the tray.

Clause 17: The method of clause 16, wherein the surface is configured to engage a projection of the tray to suppress rotation of the header relative to the tray.

Clause 18: The method of any of clauses 16 through 17, wherein rotating the header relative to the tray includes engaging the tab with the tray to suppress translation of the header in the second direction.

Clause 19: The method of any of clauses 16 through 18, wherein the second direction is opposite the first direction.

Clause 20: The method of any of clauses 16 through 19, wherein engaging the header with the tray includes engaging the base with a second base of the tray.

Clause 21: The method of any of clauses 16 through 20, wherein the tab defines a base portion and a lip extending from the base portion in a third direction.

Clause 22: The method of clause 21, wherein the third direction is orthogonal to the first direction.

Clause 23: The method of any of clauses 16 through 22, wherein disposing the tab in the second aperture of the tray includes disposing the base portion and the lip in the second aperture.

Clause 24: The method of clause 23, wherein rotating the header relative to the tray includes engaging the lip with the tray.

Clause 25: The method of clause 24, further comprising, in response to the lip engaging the tray, suppressing translation of the header in the second direction.

1. A header configured for connection with a tray, the header comprising:
a base defining a first aperture extending through the base and configured to receive a connector;
a tab extending from the base in a first direction and configured to suppress translation of the header relative to the tray in a second direction transverse to the first direction; and
a surface extending from the base in the second direction and configured to suppress rotation of the header relative to the tray.

2. The header of claim 1, wherein the tab is disposed within a second aperture of the tray.

3. The header of claim 2, wherein, in response to the tab being disposed within the second aperture, the header is configured to rotate such that the surface engages the tray.

4. The header of claim 3, wherein the surface is configured to engage the tray to suppress rotation of the header relative to the tray.

5. The header of claim 3, wherein the surface is configured to engage a projection of the tray to suppress rotation of the header relative to the tray.

6. The header of claim 1, wherein the tab is configured to engage the tray to suppress translation of the header in the second direction.

7. The header of claim 1, wherein the second direction is opposite the first direction.

8. The header of claim 1, wherein the tab includes a base portion and a lip extending from the base portion in a third direction.

9. The header of claim 8, wherein the base portion and the lip are received by a second aperture of the tray, and wherein, in response to the header being rotated so that the surface engages the tray, the lip is configured to engage the tray to suppress translation of the header in a fourth direction.

10. The header of claim 8, wherein the third direction is orthogonal to the first direction.

11. The header of claim 1, wherein the first aperture extends through the base in the first direction.

12. An assembly comprising:
the header of claim 1; and
the tray, wherein the tray includes a second aperture configured to rotatably-receive the tab.

13. The assembly of claim 12, wherein the second aperture includes a first portion defined by an arcuate surface of the base, and a second portion defined by a polygonal surface of the base, and wherein the tab is configured to translate through the second portion.

14. The assembly of claim 13, wherein the tray includes a front surface and a rear surface opposite the front surface, and wherein the rear surface is configured to engage the tab upon rotation of the header relative to the tray.

15. The assembly of claim 14, wherein the tab includes a base portion and a lip extending from the base portion in a third direction, and wherein the lip is configured to engage the rear surface upon rotation of the header relative to the tray.

16. A method of coupling a header to a tray, the header including a base defining an aperture configured to receive a connector, a tab extending from the base in a first direction, and a surface extending from the base in a second direction, the method comprising:
disposing the tab in a second aperture of the tray; and
rotating the header relative to the tray to engage the surface with the tray and, thereby, suppress rotation of the header relative to the tray.

17. The method of claim 16, wherein the surface is configured to engage a projection of the tray to suppress rotation of the header relative to the tray.

18. The method of claim 16, wherein rotating the header relative to the tray includes engaging the tab with the tray to suppress translation of the header in the second direction.

19. The method of claim 16, wherein the second direction is opposite the first direction.

20. The method of claim 16, wherein the tab defines a base portion and a lip extending from the base portion in a third direction.
